(19) United States
(12) Patent Application Publication
(10) Pub. No.: US 2009/0228612 A1
(43) Pub. Date: Sep. 10, 2009

(54) Flexible Bus Interface and Method for Operating the Same

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 12/043,244

(22) Filed: Mar. 6, 2008

(51) Int. Cl. G06F 3/00

(52) U.S. Cl. 710/14

(57) ABSTRACT

A bus interface includes a number of configuration registers and a number of enable control registers. Each configuration register corresponds to a bit set of a system bus. A value stored in a given configuration register designates a device to which the bit set corresponding to the given configuration register is allocated. The number of enable control registers are respectively associated with the number of configuration registers. A value stored in a given enable control register indicates that either a read operation or a write operation is to be performed in a given cycle of the system bus using the bit set corresponding to the configuration register associated with the given enable control register.

### BACKGROUND

1. Field of the Invention

The present invention relates to computer systems, and more particularly to a system bus interface.

2. Description of the Related Art

A computer system generally includes a multi-bit system bus to which a number of devices are connected. The system bus provides for a conveyance of data between the devices connected to the system bus. To orchestrate collaborative use of the system bus by the various devices, each device is equipped with a bus interface. The bus interface is defined to enable its device to take control of the system bus in a given bus cycle, so as to allow the device to transmit data on the system bus. The conventional bus interface provides for complete control of the entire system bus by a single device in a given bus cycle. Therefore, the conventional bus interface allows for one device to control the entire system bus in each bus cycle.

The system bus may include more bits than is required by a device connected to use the system bus. In this case, when the device has complete control of the entire system bus in a given bus cycle, the device will only use its required number of bits of the system bus, thereby leaving the remaining bits of the system bus unused in the given bus cycle. Therefore, inefficient system bus use exists when the bus interface of the device does not utilize the entire bit-width of the system bus. In some devices, such as portable consumer electronic devices (personal digital assistants (PDAs), mobile phones, pagers, web tablets, etc.), system bus access and the power required to operate each cycle of the system bus may be at a premium. Therefore, it is desirable to improve efficiency in system bus utilization.

### SUMMARY

In one embodiment, a bus interface is disclosed. The bus interface includes a number of configuration registers. Each configuration register corresponds to a bit set of a system bus. A value stored in a given configuration register designates a device to which the bit set corresponding to the given configuration register is allocated. The bus interface also includes a number of enable control registers respectively associated with the number of configuration registers. A value stored in a given enable control register indicates that either a read operation or a write operation is to be performed, in a given cycle of the system bus, using the bit set corresponding to the configuration register associated with the given enable control register.

In another embodiment, a bus interface system is disclosed. The bus interface system includes a system bus having a number of bits. The bus interface system also includes a first bus interface and a second bus interface. The first bus interface connects a central processing unit to the system bus. The second bus interface connects an external device to the system bus. Each of the first and second bus interfaces includes a plurality of configuration registers. Each configuration register is connected to store a value allocating a bit set of the system bus to be used for communication between the central processing unit and the external device.

In another embodiment, a method is disclosed for operating a bus interface. The method includes an operation for segmenting a system bus into a number of bit sets. Each bit set represents a number of consecutive bits of the system bus. The method also includes an operation for allocating each bit set for dedicated use by any one of a number of devices connected to the system bus. The method further includes an operation to indicate, for each bit set in each cycle of the system bus, whether the bit set is enabled for a read operation or a write operation. Also, an operation is provided for simultaneously operating the number of bit sets in each cycle of the system bus according to each bit set device allocation and enablement indication.

Other aspects of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a high-level schematic of an electronic system implementing a system bus, in accordance with one embodiment of the present invention;

FIG. 2 is an illustration showing a flexible bus interface, in accordance with one embodiment of the present invention;

FIG. 3 is an illustration showing an example system bus operational mode using the bus interface, in accordance with one embodiment of the present invention;

FIG. 4 is an illustration showing another example system bus operational mode using the bus interface, in accordance with one embodiment of the present invention; and

FIG. 5 is an illustration showing a flowchart of a method for operating a bus interface, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

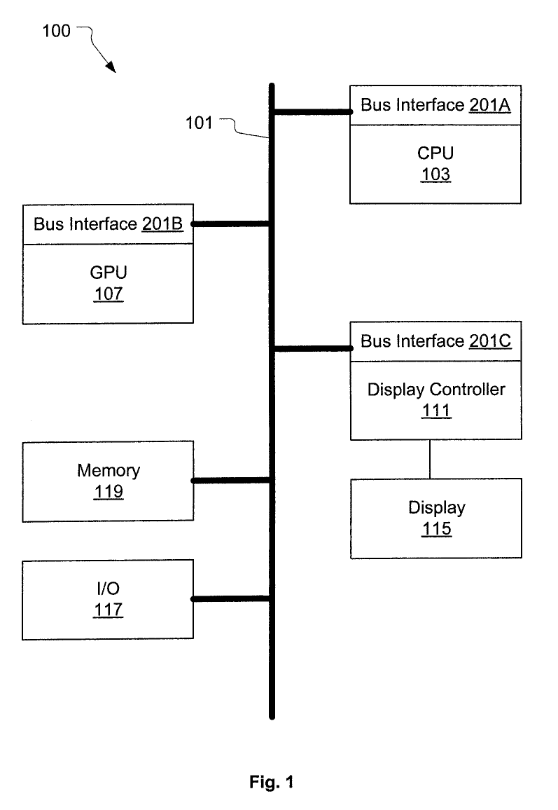

FIG. 1 is an illustration showing a high-level schematic of an electronic system 100 implementing a system bus 101, in accordance with one embodiment of the present invention. In one embodiment, the system 100 includes a central processing unit (CPU) 103 having a bus interface 201A for connecting the CPU 103 to the system bus 101. The bus interface 201A is configured to enable communication of data between a native bus of the CPU 103 and the system bus 101. The system 100 also includes a number of external devices connected to the system bus 101. For example, in one embodiment, the system 100 includes a graphics processing unit (GPU) 107 having a bus interface 201B for connecting the GPU 107 to the system bus 101. The bus interface 201B is configured to enable communication of data between a native bus of the GPU 107 and the system bus 101.

Also, in this embodiment, the system 100 includes a display controller 111 having a bus interface 201C for connecting the display controller 111 to the system bus 101. The bus interface 201C is configured to enable communication of data between a native bus of the display controller 111 and the system bus 101. The display controller 111 is defined to control operation of a display 115, such as a liquid crystal display (LCD). It should be understood that the system 100 can include essentially any number of additional external devices as required to fulfill is functional purpose, wherein each external device has a respective bus interface for connecting the external device to the system bus 101. Additionally, the system 100 can include an input/output (I/O) device 117 connected to the system bus 101, a memory 119 connected to the system bus 101, and essentially any component as required to fulfill is functional purpose.

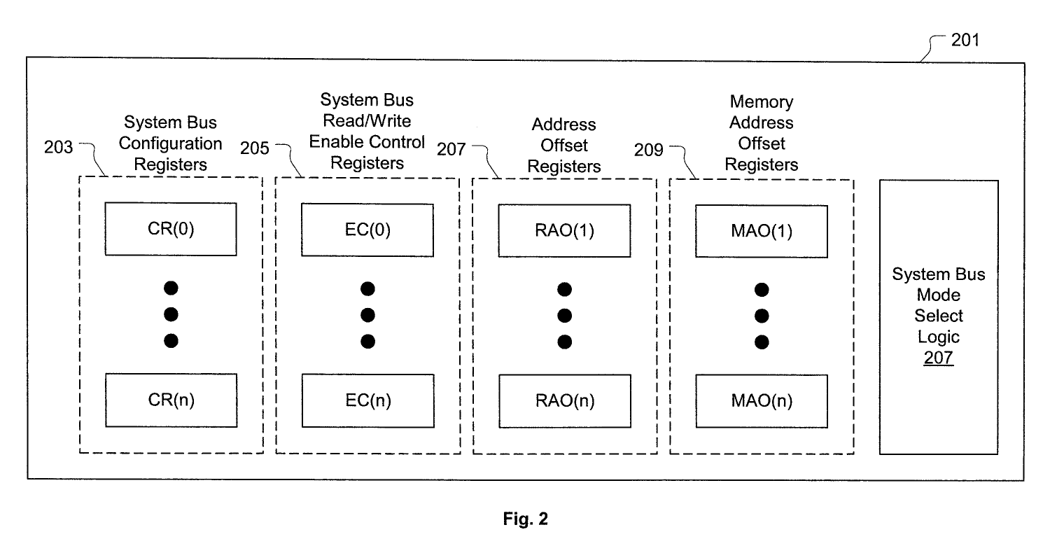

A flexible bus interface 201 is disclosed herein with regard to FIG. 2 for managing the system bus 101, such that the utilization of the system bus 101 in a given bus cycle can be optimized, thereby providing the devices connected to the system bus 101 with improved data transfer capability. By way of example, the flexible system bus interface 201 can be used for each of bus interfaces 201A-201C, as depicted the example system 100 of FIG. 1. The system bus 101 is defined by a number of bits, wherein each bit is transmitted on a respective bit line of the system bus 101. For example, in one embodiment the system bus 101 is defined by 32 bits (bit-0 through bit-31). The flexible bus interface 201 provides for division of the system bus 101 into a number of bit sets, allocation of each bit set for use by a particular device connected to the system bus 101, and indication of whether each bit set is enabled for a read operation or a write operation in a given cycle of the system bus 101, i.e., bus cycle.

As discussed further below, the flexible bus interface 201 allows for each bit set of the system bus 101 to be allocated to any device connected to the system bus 101, such that one or more bit sets may be allocated for use by any device connected to the system bus 101. Because each bit set can be used for either a read operation or a write operation in each bus cycle, allocation of the bit sets among the number of devices connected to the system bus 101 enables multiple devices to simultaneously use the system bus 101 in a given bus cycle, without regard to whether a particular device is performing a read operation or a write operation in the given bus cycle. Also, because the read/write enable control associated with each bit set can be set independently for each bus cycle, a single device allocated at least two bit sets is capable of performing simultaneous reads and writes over the system bus 101 in a given bus cycle.

FIG. 2 is an illustration showing the flexible bus interface 201 (“bus interface” 201 hereafter), in accordance with one embodiment of the present invention. The bus interface 201 includes a number of configuration registers 203, designated CR(0) through CR(n) in FIG. 2. Each of the number of configuration registers 203 corresponds to a bit set of the system bus 101. Each bit set of the system bus includes an exclusive contiguous number of bits of the system bus 101. Therefore, the bits included in a given bit set are sequentially positioned, i.e., contiguous, in the system bus 101. Also, the bits included in a given bit set cannot be included in another bit set, i.e., the bits of a given bit set are exclusive to the given bit set. The system bus 101 can be divided into essentially any number of bit sets, up to the number of bits in the system bus 101. Also, the size, i.e., number of bits, in each bit set can be set independently. Therefore, the number of bits in a given bit set can be the same or different than the number of bits in another bit set.

With regard to FIG. 2, the number configuration registers (n), corresponds to the number of bit sets to be defined, with each configuration register, CR(0) through CR(n), corresponding to a respective bit set. A value stored in a given configuration register, CR(0) through CR(n), designates a particular device to which the bit set corresponding to the given configuration register is allocated. Also, each device is connected to the system bus 101 through its own bus interface 201. For example, if the value stored in CR(0) designates the GPU 107, the bit set corresponding to CR(0) is allocated for use by the GPU 107. It should be understood that any device connected to the system bus 101 can have its designation value stored in any of the configuration registers 203. Also, it should be understood that a given device can have its designation value stored in more than one of the configuration registers 203.

Further with regard to FIG. 2, the bus interface 201 includes a number of read/write enable control registers 205, designated EC(0) through EC(n). Each of the number of read/write enable control registers 205 is associated with a respective one of the configuration registers 203, and is thereby associated with the bit set corresponding to the associated configuration register 203. For example, read/write enable control register EC(0) is associated with configuration register CR(0), and is thereby associated with the bit set corresponding to configuration register CR(0). A value stored in a given read/write enable control register, EC(0) through EC(n), indicates that either a read operation or a write operation is to be performed in a given bus cycle using the bit set corresponding to the configuration register associated with the given read/write enable control register.

It should be understood that each read/write enable control register, EC(0) through EC(n), can be independently set for each bus cycle. For example, if the designation value for the GPU 107 is stored in both CR(0) and CR(1), and EC(0) is set to indicate a read operation and EC(1) is set to indicate a write operation, the GPU 107 will use the bit set corresponding to CR(0) to perform a read operation and the bit set corresponding to CR(1) to perform a write operation in the same cycle of the system bus 101. Therefore, it should be understood that the number of configuration registers 203 and the number of read/write enable control registers 205 are connected to enable simultaneous and independent operation of each of the different bit sets in a common cycle of the system bus.

In one embodiment, when stored in a single-bit read/write enable control register, EC(0) through EC(n), a high logic state (1) indicates a read operation, and low logic state (0) indicates a write operation. In another embodiment, when stored in a single-bit read/write enable control register, EC(0) through EC(n), a high logic state (1) indicates a write operation, and low logic state (0) indicates a read operation. In another embodiment, each read/write enable control register, EC(0) through EC(n), is two-bits wide. In this embodiment, the first bit can be used for read enable, and the second bit can be used for write enable. Alternatively, the first bit can be used for write enable, and the second bit can be used for read enable. Also, in this embodiment, either a high logic state (1) or a low logic state (0) can be used to indicate read/write enablement assertion. It should be understood that implementation of the read/write enable control registers 205 is not limited to the exemplary embodiments identified above. It should be appreciated that the read/write enable control registers 205 can be implemented in essentially any manner so long as each read/write enable control register, EC(0) through EC(n), is capable of indicating whether the bit set corresponding to the configuration register associated with the read/write enable control register is to be used for a read operation or a write operation in each cycle of the system bus.

Further with regard to FIG. 2, the bus interface 201 includes a number of address offset registers 207, designated RAO(1) through RAO(n). Each of the number of address offset registers 207 is associated with a respective one of the configuration registers 203, beginning with the second configuration register CR(1), and is thereby associated with the bit set corresponding to the associated configuration register 203. For example, address offset register RAO(1) is associated with configuration register CR(1), and is thereby associated with the bit set corresponding to configuration register CR(1).

Further with regard to FIG. 2, the bus interface 201 includes a number of memory address offset registers 209, designated MAO(1) through MAO(n). Each of the number of memory address offset registers 209 is associated with a respective one of the configuration registers 203, beginning with the second configuration register CR(1), and is thereby associated with the bit set corresponding to the associated configuration register 203. For example, memory address offset register MAO(1) is associated with configuration register CR(1), and is thereby associated with the bit set corresponding to configuration register CR(1).

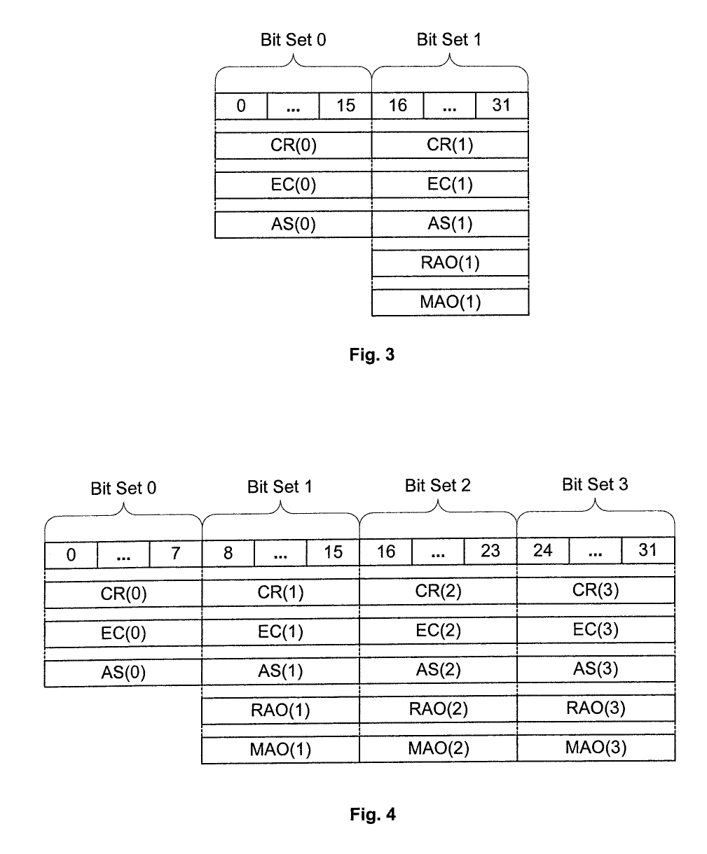

In one embodiment, a separate access signal (e.g., AS(#) as shown in FIGS. 3 and 4) is supplied for each bit set in each bus cycle to indicate whether each bit set is to be used in conjunction with register access operation or memory access operation. If the access signal for a given bit set indicates a register access operation, then the value stored in the address offset register 207 associated with the given bit set is used to determine which register address will be accessed for reading/writing in conjunction with the given bit set. Otherwise, if the access signal for a given bit set indicates a memory access operation, then the value stored in the memory address offset register 209 associated with the given bit set is used to determine which memory address will be accessed for reading/writing in conjunction with the given bit set.

In one embodiment, the base address associated with a given bus cycle is the address at which the first bit set (Bit Set (0)) associated with configuration register CR(0) will be utilized according to the setting of EC(0). The address offset value stored in a given address offset register 207 is applied to the base address of the bus cycle to determine a register address for the bit set associated with the given address offset register 207. For example, an address offset value stored in address offset register RAO(3) is applied to the base address of the bus cycle to determine a register address for Bit Set 3. Also, in this embodiment, the base address of the bus cycle is applied to Bit Set 0.

Similarly, the memory address offset value stored in a given memory address offset register 209 is applied to the base address of the bus cycle to determine a memory address for the bit set associated with the given memory address offset register 209. For example, a memory address offset value stored in memory address offset register MAO(2) is applied to the base address of the bus cycle to determine a memory address for Bit Set 2. Therefore, for a given bit set in a given bus cycle, the given bit set can be used by the specified device (as indicated by the corresponding configuration register 203) to perform either a read operation or a write operation (as indicated by the corresponding enable control register 205) at a given register address (as indicated by address offset register 207) or at a given memory address (as indicated by memory address offset register 209) depending on the state of the access signal (AS(#)) in the given bus cycle.

It should be understood that each address offset register 207, each memory address offset register 209, and the access signal (AS(#)) for each bit set can be independently set for each bus cycle. Therefore, it should be understood that both register addresses and memory addresses can be accessed by different bit sets in a simultaneous and independent manner in a common, i.e., single, cycle of the system bus.

The bus interface 201 also includes mode select logic 207 defined to enable setting of an operational mode of the bus interface 201. The operational mode of the bus interface 201 designates the number of configuration registers (n), the bit set of the system bus 101 corresponding to each configuration register (CR(0) through CR(n)), and the device to which the bit set corresponding to each configuration register (CR(0) through CR(n)) is allocated. Therefore, the operational mode of the bus interface 201 allocates one or more bits sets of the system bus 101 for independently controlled use by a particular external device connected to the system bus 101. In one embodiment, each available operational mode of the bus interface 201 is defined by circuitry within the mode select logic 207. In this embodiment, a number of select pins can be connected to the mode select logic 207 to enable selection of the bus interface 201 operational mode to be used, and thereby enable the circuitry within the mode select logic 207 associated with the operational mode to be used.

In a given bus interface 201 operational mode, the system bus 101 can be partitioned into a number of bit sets. Each bit set can be allocated for use by a particular device connected to the system bus 101. Also, each bit set can operate according to a read/write enable control signal to specify whether data present on the bit set is to be written to the system memory from the device, or read from the system memory by the device. Each device connected to the system bus 101 needs to understand how the system bus 101 is managed. Therefore, each device connected to the system bus 101 includes its own instantiation of the bus interface 201, wherein each bus interface 201 is configured to function in the same operational mode. In one embodiment, the bus interface 201A of the CPU 103 is configured to control how the system bus 101 is to be managed. In this embodiment, each bus interface (201B, 201C, etc.) in the devices (GPU 107, display controller 111, etc.) connected to the system bus 101 are configured to match the bus interface 201A of the CPU 103, thereby ensuring that the system bus 101 is operated in a consistent manner based on the operational mode set in the bus interface 201A.

FIG. 3 is an illustration showing an example system bus operational mode using the bus interface 201, in accordance with one embodiment of the present invention. In this example, the system bus is defined as a 32-bit system bus (bit-0 through bit-31). In this example, the system bus is segmented into two bit sets (Bit Set 0 and Bit Set 1), where Bit Set 0 includes bits 0 through 15, and Bit Set 1 includes bits 16 through 31. Therefore, in this example, two configuration registers (CR(0) and CR(1)) are used, and they respectively correspond to Bit Set 0 and Bit Set 1. Therefore, the value stored in CR(0) will indicate which device connected to the system bus is allocated use of Bit Set 0 (bit 0 through bit 15), and the value stored in CR(1) will indicate which device connected to the system bus is allocated use of Bit Set 1 (bit 16 through bit 31).

Also, because two configuration registers CR(0) and CR(1) are used, two read/write enable control registers EC(0) and EC(1) are used. The value stored in EC(0) will indicate whether Bit Set 0 is to be used for either a read operation or a write operation in a given cycle of the system bus 101. Similarly, the value stored in EC(1) will indicate whether Bit Set 1 is to be used for either a read operation or a write operation in a given cycle of the system bus 101. It should be appreciated that in this example, each of Bit Set 0 and Bit Set 1 can be used independently in each cycle of the system bus 101.

Also, one address offset register RAO(1) and one memory address offset register MAO(1) is provided for Bit Set 1. If in a given bus cycle an access signal AS(1) for Bit Set 1 indicates a register access operation, the value stored in RAO(1) is a register address offset to be applied to the base address associated with the given bus cycle to determine the register address to be associated with Bit Set 1. However, if in a given bus cycle the access signal AS(1) for Bit Set 1 indicates a memory access operation, the value stored in MAO(1) is a memory address offset to be applied to the base address associated with the given bus cycle to determine the memory address to be associated with Bit Set 1. The base address associated with the given bus cycle is the address associated with Bit Set 0. If an access signal AS(0) for Bit Set 0 in the given bus cycle indicates a register access operation, the base address will be considered a register address. However, if the access signal AS(0) for Bit Set 0 in the given bus cycle indicates a memory access operation, the base address will be considered a memory address.

FIG. 4 is an illustration showing another example system bus operational mode using the bus interface 201, in accordance with one embodiment of the present invention. In this example, the system bus is defined as a 32-bit system bus (bit-0 through bit-31). In this example, the system bus is segmented into four bit sets (Bit Set 0, Bit Set 1, Bit Set 2, and Bit Set 3). Bit Set 0 includes bits 0 through 7. Bit Set 1 includes bits 8 through 15. Bit Set 2 includes bits 16 through 23. Bit Set 3 includes bits 24 through 31. Therefore, in this example, four configuration registers (CR(0), CR(1), CR(2), and CR(3)) are used, and they respectively correspond to Bit Set 0, Bit Set 1, Bit Set 2, and Bit Set 3. Therefore, the value stored in CR(0) will indicate which device connected to the system bus is allocated use of Bit Set 0 (bit 0 through bit 7). The value stored in CR(1) will indicate which device connected to the system bus is allocated use of Bit Set 1 (bit 8 through bit 15). The value stored in CR(2) will indicate which device connected to the system bus is allocated use of Bit Set 2 (bit 16 through bit 23). The value stored in CR(3) will indicate which device connected to the system bus is allocated use of Bit Set 3 (bit 24 through bit 31).

Also, because four configuration registers CR(0) through CR(3) are used, four read/write enable control registers EC(0) through EC(3) are used. The value stored in EC(0) will indicate whether Bit Set 0 is to be used for either a read operation or a write operation in a given cycle of the system bus 101. The value stored in EC(1) will indicate whether Bit Set 1 is to be used for either a read operation or a write operation in a given cycle of the system bus 101. The value stored in EC(2) will indicate whether Bit Set 2 is to be used for either a read operation or a write operation in a given cycle of the system bus 101. The value stored in EC(3) will indicate whether Bit Set 3 is to be used for either a read operation or a write operation in a given cycle of the system bus 101. It should be appreciated that in this example, each of Bit Set 0 through Bit Set 3 can be used independently in each cycle of the system bus 101.

Also, three address offset registers RAO(1) through RAO(3) and three memory address offset registers MAO(1) through MAO(3) are provided for Bit Sets 1 through 3, respectively. If in a given bus cycle an access signal AS(1) for Bit Set 1 indicates a register access operation, the value stored in RAO(1) is a register address offset to be applied to the base address associated with the given bus cycle to determine the register address to be associated with Bit Set 1. If in a given bus cycle an access signal AS(2) for Bit Set 2 indicates a register access operation, the value stored in RAO(2) is a register address offset to be applied to the base address associated with the given bus cycle to determine the register address to be associated with Bit Set 2. If in a given bus cycle an access signal AS(3) for Bit Set 3 indicates a register access operation, the value stored in RAO(3) is a register address offset to be applied to the base address associated with the given bus cycle to determine the register address to be associated with Bit Set 3.

If in a given bus cycle the access signal AS(1) for Bit Set 1 indicates a memory access operation, the value stored in MAO(1) is a memory address offset to be applied to the base address associated with the given bus cycle to determine the memory address to be associated with Bit Set 1. If in a given bus cycle the access signal AS(2) for Bit Set 2 indicates a memory access operation, the value stored in MAO(2) is a memory address offset to be applied to the base address associated with the given bus cycle to determine the memory address to be associated with Bit Set 2. If in a given bus cycle the access signal AS(3) for Bit Set 3 indicates a memory access operation, the value stored in MAO(3) is a memory address offset to be applied to the base address associated with the given bus cycle to determine the memory address to be associated with Bit Set 3.

Also, the base address associated with the given bus cycle is the address associated with Bit Set 0. If an access signal AS(0) for Bit Set 0 in the given bus cycle indicates a register access operation, the base address will be considered a register address. However, if the access signal AS(0) for Bit Set 0 in the given bus cycle indicates a memory access operation, the base address will be considered a memory address.

The system bus operational mode depicted in FIG. 4 can be utilized in a variety of ways. In each bus cycle, each bit set can be utilized to performed either a read operation or a write operation to either an independently specified register address or an independently specified memory address in an independently specified device. For example, considering Bit Set 1 in a given bus cycle, the value of CR(1) specifies the device to which Bit Set 1 is allocated, the value of EC(1) specifies whether Bit Set 1 is to be used for a read operation or a write operation, the value of AS(1) specifies whether Bit Set 1 is to be used for register access operation or memory access operation, the value of RAO(1) specifies an address offset to be used in conjunction with the base address of the bus cycle to determine the register address to be accessed if a register access is to be performed, and the value of MAO(1) specifies an address offset to be used in conjunction with the base address of the bus cycle to determine the memory address to be accessed if a memory access is to be performed.

By way of example, consider that the system bus operational mode of FIG. 4 is to be used to write 8-bit data to three consecutive 8-bit registers in a given bus cycle while simultaneously reading 8-bit data from a memory in the given bus cycle, wherein the registers and memory reside in the same device. In this example, each of CR(0), CR(1), CR(2), and CR(3) is set to specify the device. In this example, each of EC(0), EC(1), and EC(2) is set to specify a write operation, and EC(3) is set to specify a read operation. In this example, each of AS(0), AS(1), and AS(2) is set to specify a register access operation, and AS(3) is set to specify a memory access operation. In this example, the base address of the bus cycle specifies the register address to which data is to be written from Bit Set 0. The value of RAO(1) is set to indicate an offset of one from the base address of the bus cycle, to identify a register address to which the data from Bit Set 1 is to be written. The value of RAO(2) is set to indicate an offset of two from the base address of the bus cycle, to identify a register address to which the data from Bit Set 2 is to be written. The values stored in MAO(1) and MAO(2) are not utilized. The value of MAO(3) is set to indicate an offset from the base address of the bus cycle to the memory address from which the data is to be read onto Bit Set 3.

The bus interface 201 allows the system bus 101 to be utilized in an optimum manner during each cycle of the system bus 101. In one embodiment, the bus interface 201 is particularly beneficial in performing a pixel read-modified-write process. In the pixel read-modified-write process, pixel data is read from memory on a pixel-by pixel basis, modified if necessary, and written back to the memory. Conventionally, the data for each pixel had to be read from memory in one system bus cycle, and written back to memory in another system bus cycle. Therefore, two system bus cycles were required for each pixel in the conventional pixel read-modified-write process. If the pixel data was defined by 16 bits, operation of a 32-bit system bus to perform the conventional pixel read-modified-write process would leave half of the system bus unused in each system bus cycle.

In one embodiment, the bus interface 201 can be configured to operate as shown in FIG. 3. In this embodiment, the values stored in CR(0) and CR(1) can be set to allocate both Bit Set 0 and Bit Set 1 for use by the GPU 107. Therefore, in this embodiment, Bit Set 0 can be used by the GPU 107 to read 16-bit pixel data from memory, and Bit Set 1 can be used by the GPU 107 to write 16-bit pixel data to memory in the same cycle of the system bus 101. More specifically, EC(0) can be set to indicate a read operation on Bit Set 0, and EC(1) can be set to indicate a write operation on Bit Set 1, in each cycle of the system bus 101. Therefore, in performing a pixel read-modified-write process the GPU 107 can both read pixel data from an address (x) of the memory using Bit Set 0 and simultaneously write modified pixel data to an address (x-1) of the memory using Bit Set 1, in a single cycle of the system bus 101. Thus, when modified 16-bit pixel data is being written back to memory by the GPU 107 using Bit Set 1, the next 16-bit pixel data can be simultaneously read from memory by the GPU 107 using Bit Set 0.

To illustrate the benefit of the bus interface 201 in performing the pixel read-modified-write process, consider a 128 pixel by 160 pixel display to be subjected to the pixel read-modified-write process. The display includes 20480 total pixels. Using the conventional read-modified-write process, one cycle of the 32-bit system bus is required to read 16 bits of data for one pixel from memory, and another cycle of the 32-bit system bus is required to write 16 bits of data for one pixel to memory. Therefore, it takes two cycles of the 32-bit system bus to process one pixel. Thus, using the conventional pixel read-modified-write process, 40960 cycles of the 32-bit system bus are required to process the entire display.

In contrast, using the bus interface 201, 16-bit pixel data for the first pixel can be read from memory in a first cycle of the 32-bit system bus. Then, in each subsequent cycle of the 32-bit system bus, 16-bit pixel data can be read from memory for the next pixel while modified 16-bit pixel data for the previous pixel is simultaneously written to memory. Therefore, it takes 20481 cycles of the 32-bit system bus to process the entire display using the benefits afforded by the bus interface 201. Thus, the bus interface 201 allows the number of system bus cycles required to perform the pixel read-modified-write process to be effectively cut in half.

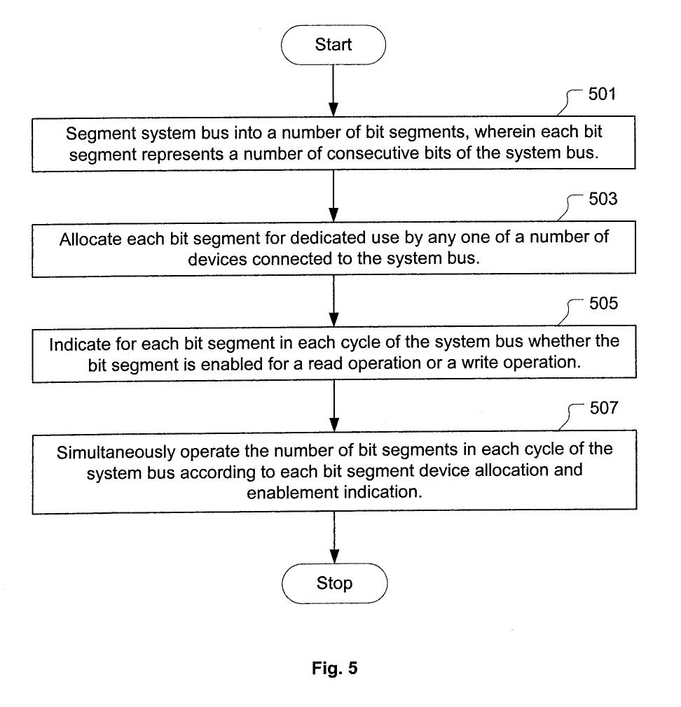

FIG. 5 is an illustration showing a flowchart of a method for operating a bus interface, in accordance with one embodiment of the present invention. The method includes an operation 501 for segmenting a system bus into a number of bit sets, wherein each bit set represents a number of consecutive bits of the system bus. In one embodiment, segmenting the system bus into the number of bit sets is performed by connecting the bits of a given bit set so as to be controlled by a configuration register uniquely associated with the given bit set. Also, it should be understood that the bit sets of the system bus are exclusively defined with respect to each other.

The method also includes an operation 503 for allocating each bit set for dedicated use by any one of a number of devices connected to the system bus. In one embodiment, allocating each bit set for dedicated use by any one of the number of devices connected to the system bus is performed by storing a device identifier value in the configuration register uniquely associated with the bit set. The method also includes an operation 505 for indicating for each bit set in each cycle of the system bus whether the bit set is enabled for a read operation or a write operation. The method further includes an operation 507 for simultaneously operating the number of bit sets in each cycle of the system bus according to each bit set device allocation and enablement indication.

In one embodiment, operation 501 is performed to segment the system bus into at least two bit sets of equal size. In this embodiment, operation 503 is performed to allocate the at least two bit sets for dedicated use by a common device. Also in this embodiment, operation 505 is performed to enable a first one of the at least two bit sets for use in performing a read operation, and to enable a second one of the at least two bit sets for use in performing a write operation. Then, in operation 507 of this embodiment, the common device simultaneously performs both read and write operations in a single cycle of the system bus.

In one instance of the above embodiment, the common device is a graphics processing unit. In this instance, the first one of the at least two bit sets is used to read pixel data from a system memory, and the second one of the at least two bit sets is used to write pixel data to the system memory. Therefore, in this instance of the above embodiment, the graphics processing unit can be operated to perform a pixel read-modified-write process by reading pixel data from the system memory while simultaneously writing modified pixel data back to the system memory in a single cycle of the system bus.

One skilled in the art will appreciate that the circuitry required to implement the bus interface 201 in hardware can be defined on a semiconductor chip using logic gates configured to provide the required functionality. For example, a hardware description language (HDL) can be employed to synthesize hardware and a layout of the logic gates for providing the necessary functionality described herein.

With the above embodiments in mind, it should be understood that the present invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

What is claimed is:

1. A bus interface, comprising:
a number of configuration registers, each configuration register corresponding to a bit set of a system bus, wherein a value stored in a given configuration register designates a device to which the bit set corresponding to the given configuration register is allocated; and
a number of enable control registers respectively associated with the number of configuration registers, wherein a value stored in a given enable control register indicates that either a read operation or a write operation is to be performed in a given cycle of the system bus using the bit set corresponding to the configuration register associated with the given enable control register.

2. A bus interface as recited in claim 1, wherein each bit set of the system bus includes an exclusive contiguous number of bits of the system bus.

3. A bus interface as recited in claim 1, wherein the bus interface is disposed within a device connected to the system bus to enable communication of data between a native bus of the device and the system bus.

4. A bus interface as recited in claim 1, wherein the number of configuration registers and the number of enable control registers are connected to enable simultaneous use of each of the different bit sets in a common cycle of the system bus.

5. A bus interface as recited in claim 1, further comprising:
mode select logic defined to enable setting of an operational mode, wherein the operational mode designates the number of configuration registers, the bit set corresponding to each configuration register, and the device to which the bit set corresponding to each configuration register is allocated.

6. A bus interface as recited in claim 1, wherein the system bus includes thirty-two bits, and the number of configuration registers is two, such that a first bit set of sixteen bits corresponds to a first configuration register, and such that a second bit set of sixteen bits corresponds to a second configuration register, wherein the first and second bit sets are exclusive of each other.

7. A bus interface as recited in claim 1, wherein the system bus includes thirty-two bits, and the number of configuration registers is four, such that a first bit set of eight bits corresponds to a first configuration register, and such that a second bit set of eight bits corresponds to a second configuration register, and such that a third bit set of eight bits corresponds to a third configuration register, and such that a fourth bit set of eight bits corresponds to a fourth configuration register, wherein the first, second, third, and fourth bit sets are exclusive of each other.

8. A bus interface system, comprising:
a system bus including a number of bits;
a first bus interface connecting a central processing unit to the system bus; and
a second bus interface connecting an external device to the system bus,
wherein each of the first and second bus interfaces includes a plurality of configuration registers, each configuration register connected to store a value allocating a bit set of the system bus to be used for communication between the central processing unit and the external device.

9. A bus interface system as recited in claim 8, wherein the first bus interface is configured to enable communication of data between a native bus of the central processing unit and the system bus, and wherein the second bus interface is configured to enable communication of data between a native bus of the external device and the system bus.

10. A bus interface system as recited in claim 8, wherein each of the first bus interface and the second bus interface includes mode select logic defined to enable setting of an operational mode, wherein the operational mode allocates one or more bit sets of the system bus for independently controlled use by the external device.

11. A bus interface system as recited in claim 8, wherein the external device is a graphics processing unit, and wherein the bus interface system is disposed within an embedded device.

12. A bus interface system as recited in claim 8, wherein each of the first and second bus interfaces includes a number of enable control registers respectively corresponding to the number of configuration registers, each enable control register connected to store a value indicating whether a read operation or a write operation is to be performed in a given cycle of the system bus using the bit set allocated according to the value stored in the corresponding configuration register.

13. A bus interface system as recited in claim 12, wherein the number of configuration registers and the number of enable control registers are connected in each of the central processing unit and external device to enable simultaneous and independent operation of the bit sets in a common cycle of the system bus.

14. A bus interface system as recited in claim 12, wherein the external device is a graphics processing unit, and wherein a first configuration register stores a value allocating a first bit set to the graphics processing unit, and wherein a second configuration register stores a value allocating a second bit set to the graphics processing unit, and wherein a first enable control register stores a value indicating that the first bit set is to be used for a read operation, and wherein a second enable control register stores a value indicating that the second bit set is to be used for a write operation, such that in performing a read-modified-write process the graphics processing unit is configured to both read pixel data from a system memory using the first bit set and simultaneously write modified pixel data to the system memory using the second bit set in a single cycle of the system bus.

15. A method for operating a bus interface, comprising:
segmenting a system bus into a number of bit sets, wherein each bit set represents a number of consecutive bits of the system bus;
allocating each bit set for dedicated use by any one of a number of devices connected to the system bus;
indicating for each bit set in each cycle of the system bus whether the bit set is enabled for a read operation or a write operation; and
simultaneously operating the number of bit sets in each cycle of the system bus according to each bit set device allocation and enablement indication.

16. A method for operating a bus interface as recited in claim 15, wherein the system bus is segmented into at least two bit sets of equal size, and wherein the at least two bit sets are allocated for dedicated use by a common device, and in a given cycle of the system bus a first one of the at least two bit sets is enabled for a read operation and a second one of the at least two bit sets is enabled for a write operation, such that the common device simultaneously performs both read and write operations in the given cycle of the system bus.

17. A method for operating a bus interface as recited in claim 16, wherein the common device is a graphics processing unit, and wherein the first one of the at least two bit sets is used to read pixel data from a system memory, and wherein the second one of the at least two bit sets is used to write pixel data to the system memory, such that in performing a read-modified-write process pixel data can be read from the system memory while simultaneously writing modified pixel data back to the system memory in a single cycle of the system bus.

18. A method for operating a bus interface as recited in claim 15, wherein segmenting the system bus into the number of bit sets is performed by connecting the bits of a given bit set so as to be controlled by a configuration register uniquely associated with the given bit set.

19. A method for operating a bus interface as recited in claim 18, wherein allocating each bit set for dedicated use by any one of the number of devices connected to the system bus is performed by storing a device identifier value in the configuration register uniquely associated with the bit set.

20. A method for operating a bus interface as recited in claim 15, wherein the bit sets of the system bus are exclusively defined with respect to each other.
